(19) United States
(12) Patent Application Publication
(10) Pub. No.: US 2019/0137974 A1
(43) Pub. Date: May 9, 2019

(54) METHOD, ASSISTANCE SYSTEM AND 3D-PRINTER FOR COMPUTER-AIDED DESIGN OF OBJECTS FOR ADDITIVE MANUFACTURING

(71) Applicant: Siemens Aktiengesellschaft, München (DE)

(72) Inventors: Utz Wever, München (DE); David Vitoux, München (DE); Stefan Gavranovic, Putzbrunn (DE); Dirk Hartmann, Aßling (DE)

(21) Appl. No.: 16/307,352

(22) PCT Filed: May 26, 2017
(86) PCT No.: PCT/EP2017/062732

§ 371 Date: Dec. 5, 2018

(30) Foreign Application Priority Data
Jun. 15, 2016 (DE) 10 2016 210 643.0

(51) Int. Cl. G05B 19/4099; G06F 17/50; B33Y 50/02

(52) U.S. Cl. CPC G05B 19/4099; G06F 17/5018; B33Y 50/02; B33Y 30/00; G05B 2219/35134; G05B 2219/49007; G06F 2217/12

(57) ABSTRACT

Design data are input for an object to be additively manufactured and to be optimised in terms of a physical optimisation target is provided. A volumetric model of the object is initialised with a material distribution according to the design data, the volumetric model having a plurality of volume elements. A respective local target property relating to the optimisation target is then determined for volume elements of the volumetric model, based on the material distribution. According to embodiments of the invention, each volume element is checked to determine whether the volume element is supported in terms of additive manufacturing. Based on this, the target property of this volume element is modified in such a way that it approaches the target property if it is supported and/or moves away from the optimisation target if it is not supported.

### CROSS-REFERENCE TO RELATED APPLICATIONS

This application claims priority to PCT Application No. PCT/EP2017/062732, having a filing date of May 26, 2017, based off of German Application No. 10 2016 210 643.0, having a filing date of Jun. 15, 2016, the entire contents both of which are hereby incorporated by reference.

### FIELD OF TECHNOLOGY

In contemporary production processes, additive manufacturing is becoming increasingly significant. It permits products having almost arbitrarily complex outlines and topologies to be produced with relatively little effort. Compared with conventional manufacturing methods, only few design constraints need to be observed with additive manufacturing. A substantial constraint that needs to be borne in mind with additive manufacturing, however, is that surfaces and edges that overhang to a greater extent normally require a supporting structure during printing, since they would otherwise initially not be connected or would be connected too weakly to other parts of the object to be manufactured in the case of a layered construction. Supporting structures of this kind need to be added to overhanging surfaces of the object by design prior to printing and need to be removed again after printing, which frequently requires considerable additional effort.

### BACKGROUND

Although known assistance systems for designing objects to be produced frequently assist the designer in making use of an abundance of shapes accessible to additive manufacturing, constraints specific to additive manufacturing, in particular design constraints, are normally not automatically factored in.

### SUMMARY

An aspect relates to a method, an assistance system and a 3D printer for computer-aided design of objects for additive manufacturing that are able to avoid the aforementioned disadvantages.

According to embodiments of the invention, computer-aided design of objects for additive manufacturing involves design data being read in for an object that is to be additively manufactured and to be optimized in consideration of a physical optimization target. The design data in this instance can indicate in particular required properties of the object and/or stipulations for the object, such as, for example, dimensions, shape stipulations, loading capacity, forces acting on the object, local/global constraints and/or parameters to be optimized, such as in particular stresses or deformations. The optimization target provided may in particular be to minimize accumulated deformations/stresses under load, to minimize a weight/volume of the object and/or to optimize an air circulation or cooling. A material distribution according to the design data is used to initialize a volumetric model of the object, comprising a multiplicity of volume elements. The volumetric model can in this instance be represented by a data structure that stores one or more material values, such as in particular a material density, for each volume element. A respective local target property relating to the optimization target is then ascertained for volume elements of the volumetric model on the basis of the material distribution. The target property can in this instance indicate in particular a local influence of the material distribution on the optimization target and can in particular be ascertained by means of a simulation of the physical properties of the object. According to embodiments of the invention, a check is performed for a respective volume element to ascertain whether this volume element is supported in consideration of additive manufacturing. This is taken as a basis for modifying the target property of this volume element such that the target property approaches the optimization target if there is support and/or moves away from the optimization target if there is no support. A volume element can be regarded as supported in particular if it is supported mechanically by a material-filled volume element beneath it or by an exterior supporting element. The modified target properties are taken as a basis for modifying the material distribution such that the modified material distribution approaches the optimization target. The modified material distribution is then output for additive manufacturing of the object.

An assistance system according to embodiments of the invention is configured to perform the above method.

A 3D printer according to embodiments of the invention is configured to perform the above method and to print the designed object.

Additionally, a computer program product (non-transitory computer readable storage medium having instructions, which when executed by a processor, perform actions) and a computer-readable storage medium are provided to perform the method according to embodiments of the invention.

A fundamental advantage of embodiments of the invention can be regarded as being that surfaces and edges overhanging to an excessive extent can be “optimized out” to a certain degree by the optimization process. Explicit addition of supporting structures—and hence also removal thereof—and ascertainment of whether and where supporting structures need to be added can therefore be dispensed with for the most part. It is normally found that local modification of the target properties as part of the optimization process leads to almost all material-filled volume elements being supported adequately overall. Additionally, a total mass or a total volume of the object is not modified by supporting structures, which would hamper optimization of the total mass or of the total volume. A self-supporting design is instead automatically obtained as the result of the optimization process. In particular, no postprocessing of the optimized volumetric model is required. Furthermore, the method according to embodiments of the invention requires considerably fewer computation resources than if a support requirement were called for as a direct constraint for each volume element in the optimization process. This allows the optimization process to be speeded up in many cases such that even an interactive change in the design data is possible during the optimization process.

The method steps for ascertaining the local target property, the check to ascertain whether a respective volume element is supported, this being taken as a basis for modifying the target property, and the modification of the material distribution, can be repeated until a stipulated optimization criterion is satisfied. The optimization criterion used can be, by way of example, a convergence of an optimization method used, an adequate robustness and/or an adequate material consumption by the object to be designed or attainment of another optimization requirement.

According to one advantageous embodiment of the invention, the volume-element-specific ascertainment of the target properties can be effected by means of a finite element method. A multiplicity of standardized, robust and efficient methods and procedures are available for performing a finite element method.

Advantageously, the optimization target can be represented by a target function that computes a distance of a respective material distribution from the optimization target and/or a physical magnitude of this material distribution that needs to be optimized. The target function can in particular be implemented by means of a program routine and/or a data structure. The stipulation of a target function allows the optimization target to be specified in a simple manner and integrated into an optimization process.

Additionally, the target property ascertained for a respective volume element can be how the target function changes in the event of a change in a material density in this volume element. In particular, the target property provided can be a local gradient of the target function in the respective volume element, i.e. a numerical derivation, in particular a difference quotient, of the target function according to the material density of the volume element under consideration. A target property of this kind can be used to optimize the material density in a simple manner using widely available optimization methods.

According to an advantageous embodiment of the invention, the check on the support for a respective volume element can involve checking whether a cone downwardly directed from this volume element and having a stipulated apex angle meets another material-filled volume element or a supporting element.

According to a further advantageous embodiment of the invention, the check on support for the respective volume element can involve checking whether this volume element supports another volume element in consideration of additive manufacturing. This can be taken as a basis for modifying the target property of the respective volume element such that the target property approaches the optimization target if there is support and/or moves away from the optimization target if there is no support.

In particular, the check to ascertain whether the respective volume element supports another volume element can involve checking whether a cone upwardly directed from the respective volume element and having a stipulated apex angle meets another material-filled volume element.

The effect that can normally be achieved in a simple manner by the above checks on support is that the result of the optimization process is that an object is designed in which overhang angles of object surfaces or edges are substantially less than or equal to the stipulated apex angle. By stipulating a suitable apex angle the addition of supporting structures can thus specifically be avoided.

### BRIEF DESCRIPTION

Some of the embodiments will be described in detail, with references to the following figures, wherein like designations denote like members, wherein:

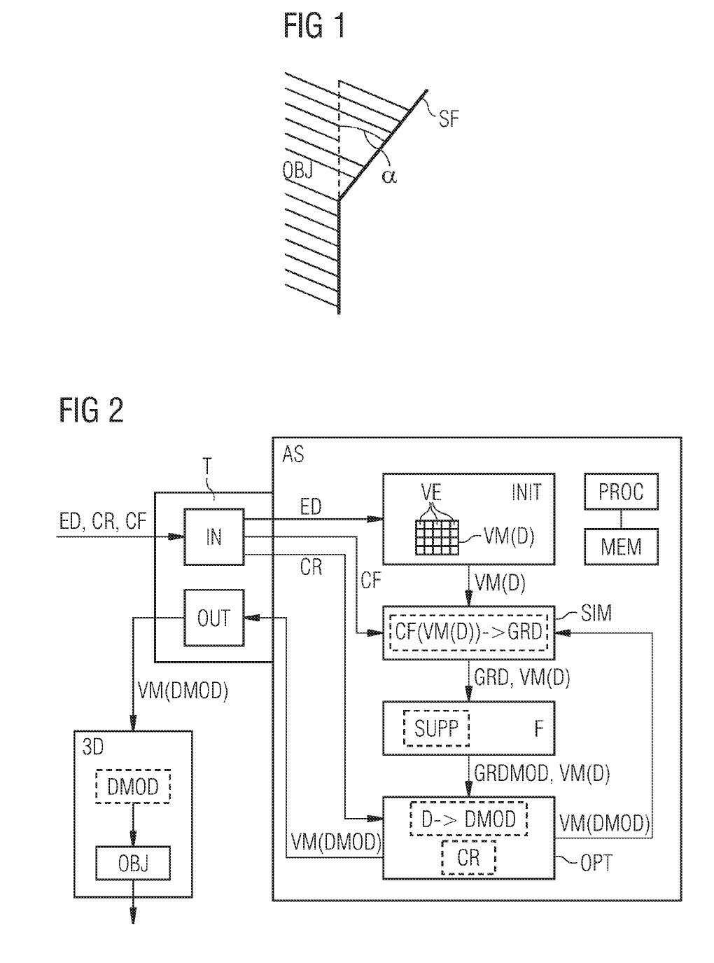

FIG. 1 shows an overhanging lateral face of an object to be printed;

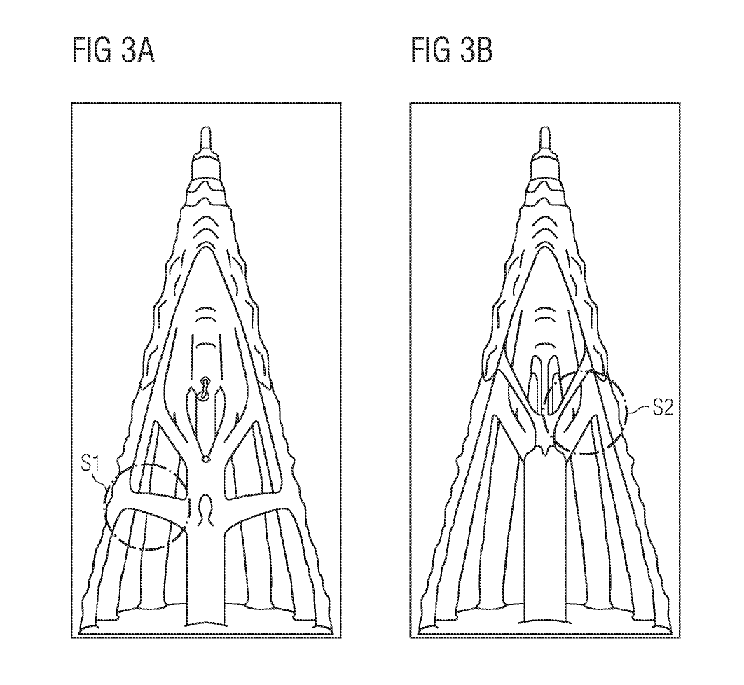

FIG. 2 shows an assistance system with a 3D printer for designing and additively manufacturing objects;

FIG. 3A shows a cut-open view of a model of an object to be printed that is optimized according to the known art; and

FIG. 3B shows a cut-open view of a model of the object that is optimized according to embodiments of the invention.

### DETAILED DESCRIPTION

FIG. 1 illustrates an overhanging lateral face SF of an object OBJ to be additively manufactured, e.g. to be printed by a 3D printer. The overhang angle α in this instance refers to an angle of the object surface SF in relation to the perpendicular. As already mentioned above, if the overhang angle α is too large, supporting structures additionally need to be added before printing and removed again after printing. While an overhang angle α of less than 45° is frequently acceptable, an overhang angle α of more than 45° can require additional supporting structures to be added.

FIG. 2 shows an assistance system AS for designing an object OBJ to be additively manufactured and a 3D printer 3D for printing the designed object OBJ. The assistance system AS has one or more processors PROC configured to perform all the method steps of the assistance system AS and/or to perform program instructions for performing these method steps. Furthermore, the assistance system AS has one or more memories MEM coupled to the processors PROC for storing data to be processed by the assistance system AS.

The assistance system AS additionally has a terminal T having an input terminal IN and having an output terminal OUT. The input terminal IN is used for inputting and/or specifying design data ED, an optimization criterion CR and a target function CF. The output terminal OUT is used for outputting a volumetric model VM with a material distribution of the designed object OBJ.

The design data ED to be read in or specified can be implemented by data structures indicating properties of the object OBJ that are called for and/or stipulations for the object OBJ. These details can relate to e.g. dimensions, shape stipulations, shapes of object parts, forces acting on the object or parts thereof, a loading capacity of the object, local and/or global constraints, static and/or dynamic properties of the object and/or design parameters to be optimized. A global constraint that can be indicated is e.g. a maximum material-filled volume or a maximum weight of the object. The design parameter to be optimized that can be stipulated is e.g. deformations and/or stresses of the object under load that need to be minimized.

The target function CF is a physical optimization target. The target functions CF computes a distance of a respective material distribution from the optimization target on the basis of a stipulated measure of distance and/or a physical magnitude that is to be optimized for the material distribution. The target function CF can be implemented e.g. as a program routine that is input and/or selected and/or specified by means of an input. In particular, the target function CF can be implemented by means of a data structure that specifies and/or parameterizes the target function CF. A target function of this kind is frequently also referred to as a cost function within the context of optimization methods.

The physical optimization target that can be stipulated is, by way of example, that the object OBJ to be designed has the smallest possible accumulated deformations and/or stresses under load below a breaking point. Additionally, the physical optimization target can be directed at a minimum weight and/or volume of the object OBJ, a good air circulation and/or cooling or at a weighted combination of the above optimization criteria. A value of the target function CF, i.e. a respective distance of a current material distribution of the object OBJ from the physical optimization target, is computed by simulating the physical properties of the object OBJ, e.g. by means of a finite element method on the basis of a volumetric model of the object OBJ. To compute the target function CF, squared deformations and/or stresses of the object OBJ can be numerically integrated overall volume elements of the volumetric model, for example.

The optimization criterion CR indicates attainment of an optimization requirement and can be implemented by one or more data structures. As such, the optimization criterion CR stipulated can be a threshold value for the target function CF, which threshold value stipulates when a distance from the physical optimization target is sufficiently short in view of the design stipulations and/or when a physical magnitude to be optimized for the relevant material distribution is adequately optimized. The optimization criterion CR can in particular relate to a convergence of an optimization method, an adequate robustness of the object OBJ, an adequate material consumption, a safe interval below a breaking point or an interval below a stipulated object volume.

The design data ED are transmitted from the input terminal IN to an initialization module INIT of the assistance system AS. The initialization module INIT generates and initializes a volumetric model VM of the object OBJ with a material distribution D according to the design data ED and outputs the initialized volumetric model VM.

In the present exemplary embodiment, the volumetric model VM is a three dimensional model of the object OBJ with a multiplicity of volume elements VE arranged e.g. in a three dimensional grid or in a three dimensional triangulation. The volumetric model VM is represented by a spatially resolved data record that stores e.g. a density value or other material values for each point and/or each volume element of the three dimensional grid or of the three dimensional triangulation. Continuous or quasi-continuous density values are permitted in this case so that the resulting optimization problem becomes constant and/or differentiable. However, the optimization problem can then advantageously be put forward such that discrete values of the density, e.g. 0 and 1, are exemplary during optimization such that, following optimization, substantially only these discrete density values arise. Intermediate values can be “optimized out” to a certain degree as a result. On the basis of a volume model discretized in such a manner, the object OBJ can be printed by standard 3D printers directly, these frequently only having the option to add material to a respective volume element of the object OBJ or to add no material.

The volume elements VE on a three dimensional grid or a three dimensional triangulation are frequently also referred to as voxels. In realistic object designs, the number of volume elements VE can typically be 10⁵, 10⁶ or more.

In the present exemplary embodiment, the material distribution D is indicated by a spatially resolved material density in the volumetric model VM, i.e. a volume-element-specific value for the material density is stored in the volumetric model VM for each volume element VE.

The volumetric model VM can be generated and initialized by the initialization module INIT such that the material distribution D initially represents e.g. a solid cuboid, cylinder or cone, i.e. the material density is set to 1 in all volume elements inside the cuboid, cylinder or cone and to 0 outside. In course of design optimization, it is then possible for material-filled volume elements to be reduced, provided that this is not detrimental to robustness, and in this way for a volume and/or weight reduction to be achieved. An example of a volumetric model first initialized as a solid cone and then optimized in consideration of the material-filled volume is depicted schematically in FIGS. 3A and 3B.

The volumetric model VM with the material distribution D is transmitted from the initialization module INIT to a simulation module SIM and is transmitted from the latter via a filter module F to an optimization module OPT. Alternatively or additionally, the volumetric model VM with the material distribution D can be stored in the memory MEM with access by the initialization module INIT, the simulation module SIM, the filter module F and by the optimization module OPT.

The simulation module SIM is used for simulating physical properties of the volumetric model VM. For this purpose, the simulation module SIM receives the target function CF from the input terminal IN. Next, the simulation module SIM reads in the volumetric model VM from the initialization module INIT, from the memory MEM or, as will be explained below, from the optimization module OPT. To simulate both static and dynamic physical properties of the volumetric model VM, what is known as a finite element method is used. A multiplicity of robust and efficient methods and procedures are available for performing finite element methods of this kind. As part of the simulation, the simulation module SIM ascertains a specific value of the target function CF for the currently read-in volumetric model VM with the material distribution D and, for each volume element VE, a volume-element-specific local target property GRD relating to the physical optimization target. The local target property GRD indicates a local influence of the material distribution D on the physical optimization target. The local target property GRD for a volume element VE indicates how the target function CF changes in the event of a change in the material density in this volume element VE. This can relate to e.g. a change in deformations, stresses, cooling properties or in weighted combinations thereof in the event of a local change in the material density. All of the local target properties GRD are ascertained by means of simulation of the physical properties on the basis of the volumetric model VM. In the present exemplary embodiment, the local target property GRD used is a local gradient of the target function CF in the respective volume element VE, i.e. a numerical derivation of the target function CF according to the local material density in the volume element VE under consideration. All of the local target properties GRD can be implemented by a spatially resolved data record by virtue of the respective local gradient being stored for each volume element VE.

The local target properties GRD are transmitted from the simulation module SIM to the filter module F. The filter module F uses the volumetric model VM to perform a check on support SUPP and modifies the local target properties GRD to produce modified target properties GRDMOD.

The check on support SUPP involves checking whether a respective material-filled volume element VE is supported in consideration of additive manufacturing. A volume element VE under consideration is regarded as supported in this instance if it is mechanically supported by another material-filled volume element or by an exterior supporting element, e.g. a base area or another supporting surface of the object OBJ, such that no separate support structures are needed during additive manufacturing, e.g. during 3D printing.

In the present exemplary embodiment, the above purpose is served by virtue of a check initially being performed for each volume element VE of the volumetric model VM to ascertain whether the volume element VE under consideration is material-filled, e.g. by checking whether the material density in the volume element VE under consideration is above a stipulated threshold value. If the volume element VE under consideration is found to be material-filled, a check is next performed to ascertain whether a cone downwardly directed from this material-filled volume element VE and having a stipulated apex angle meets another material-filled volume element or a supporting element. This involves the other volume element being looked for in a layer of the volumetric model VM that is to be printed immediately before the layer of the volume element VE under consideration. The check to ascertain whether the other volume element is material-filled can likewise be effected by means of comparison with the aforementioned threshold value. If the cone meets another material-filled volume element, the volume element under consideration can be regarded as supported. If the volume element VE under consideration is supported, the local gradient GRD for this volume element is increased, otherwise reduced, so as to obtain a modified local gradient GRDMOD. As a result of this modification, the local target property approaches the optimization target if there is support and moves away from the optimization target if there is no support. This means that supported structures are exemplary over unsupported structures in the subsequent optimization step directed at the optimization target.

Advantageously, the check on support SUPP can additionally involve checking whether a material-filled volume element VE under consideration supports another material-filled volume element in consideration of additive manufacturing. For this purpose, it is possible to check whether a cone upwardly directed from the volume element VE under consideration and having a stipulated apex angle meets another material-filled volume element. If this is the case, the volume element VE under consideration can be regarded as a supported volume element. The other volume element can be looked for in this instance in a layer of the volumetric material VM that is to be printed immediately after the layer of the volume element VE under consideration. If the volume element VE under consideration is found to be supporting, the local gradient GRD of the volume element VE under consideration is increased, otherwise reduced. In this manner, a local target property of a supporting volume element approaches the optimization target, while the local target property of a nonsupporting volume element moves away from the optimization target. Thus, supporting volume elements are exemplary over nonsupporting volume elements during the subsequent optimization step.

The same apex angles, e.g. an apex angle of ≤60° or ≤45°, are stipulated for the upwardly directed cones and for the downwardly directed cones. As a result of the preference for supported and/or supporting material-filled volume elements over unsupported and/or nonsupporting volume elements, larger overhang angles are “optimized out” to a certain degree in the course of the optimization process. In fact, it can normally be established that the object structures obtained as a result of a convergent optimization process have almost throughout only such overhang angles as are less than or equal to the apex angle of the above cones. Suitable choice of these apex angles allows the object OBJ to be automatically designed by the optimization process such that no additional object structures need to be added before printing and removed after printing.

The local gradients modified in the manner above are transmitted as modified target properties GRDMOD from the filter module F to the optimization module OPT. For this purpose, the filter module F acts as a filter for the local target properties GRD.

In the present exemplary embodiment, the optimization module OPT performs an iterative optimization process in order to modify the material distribution D such that a value of the target function CF is minimized or reduced. A multiplicity of standard optimization methods are available for implementing this optimization process, e.g. what are known as steepest descent methods or simplex methods. The optimization process is performed iteratively until the optimization criterion CR is satisfied, e.g. until the distance of an ascertained material distribution from the optimization target is sufficiently short or other optimization requirements have been attained. For this purpose, the optimization criterion CR is transmitted from the input terminal IN to the optimization module OPT.

The optimization module OPT modifies the material distribution D of the volumetric model VM on the basis of the modified target properties GRDMOD such that the modified material distribution DMOD approaches the optimization target during an optimization step, i.e. an iteration step. The optimization criterion CR is applied to the modified material distribution DMOD of the volumetric model VM in order to establish whether the modified material distribution DMOD is consistent with an optimization requirement. If the optimization criterion CR is not yet satisfied, the volumetric model VM with the modified material distribution DMOD is transmitted from the optimization model OPT to the simulation module SIM and in this way a further iteration step or execution of a loop for the volumetric model VM with the modified material distribution DMOD is prompted. A respective iteration step of this loop is, as already described above, performed by the simulation module SIM, the filter module F and by the optimization module OPT.

If the optimization criterion CR for the modified material distribution DMOD is satisfied, the iteration is terminated and the loop is left. In this case, the volumetric model VM with the modified material distribution DMOD is output via the output terminal OUT as a design of the object OBJ.

As already mentioned above, the design optimized in this manner normally has almost no overhang angles larger than the apex angles of the cones used, which means that this design can be printed without supporting structures that additionally need to be added. The method according to embodiments of the invention requires considerably fewer computational resources for optimizing the design than if a support requirement were called for as a direct constraint for each volume element in the optimization process. This resource-saving optimization permits an interactive change in the design data ED during the ongoing optimization process in many cases. That is to say that the design data ED can be changed interactively on the basis of the optimized design and a new optimization cycle can be prompted so as to generate a new optimized design. The design for the object OBJ that is to be printed in the end is transmitted in the form of the volumetric model VM with the optimized material distribution DMOD from the output terminal OUT to the 3D printer 3D. The latter then prints the object OBJ having an optimized design using the optimized material distribution DMOD. Since no additionally supporting structures need to be added to the optimized design, they also do not need to be removed from the printed object.

FIG. 3A shows a cut-open view of a model of a conical object to be printed that is optimized according to the prior art. As is evident in FIG. 3A, this design has multiple locations with a large overhang angle, among which a strut S1 is highlighted by a circle. The strut S1 and the other locations with a large overhang would need to be provided with suitable supporting structures before 3D printing, and these would need to be removed in an additionally operation after printing.

In contrast to FIG. 3A, FIG. 3B shows a cut-open view of a model of the conical object that is optimized according to embodiments of the invention. As is easy to see, struts with a large overhang, such as e.g. the strut S1 in FIG. 3A, have been “optimized out” to a certain degree in FIG. 3B. In fact, FIG. 3B contains only struts S2 having a small overhang angle permissible for 3D printing. Overall, a permissible overhang angle is essentially not exceeded in the model depicted in FIG. 3B. Therefore, the model depicted in FIG. 3B is printable without supporting structures that additionally need to be added, and the printed object accordingly requires no finishing in this regard.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for computer-aided design of objects for additive manufacturing, wherein
a) design data are read in for an object that is to be additively manufactured and to be optimized in consideration of a physical optimization target,
b) a volumetric model of the object, comprising a multiplicity of volume elements, is initialized with a material distribution according to the design data,
c) a respective local target property relating to the optimization target is ascertained for volume elements of the volumetric model on the basis of the material distribution,
d) a check is performed for a respective volume element to ascertain whether this volume element is supported in consideration of additive manufacturing, and this is taken as a basis for modifying the target property of this volume element such that the target property approaches the optimization target if there is support and/or moves away from the optimization target if there is no support,
e) the modified target properties are taken as a basis for modifying the material distribution such that the modified material distribution approaches the optimization target, and
f) the modified material distribution is output for additive manufacturing of the object.

2. The method as claimed in claim 1, wherein method steps c) to e) are repeated until a stipulated optimization criterion is satisfied.

3. The method as claimed in claim 1, wherein
the volume-element-specific ascertainment of the target properties is effected by a finite element method.

4. The method as claimed in claim 1, wherein
the optimization target is represented by a target function that computes a distance of a respective material distribution from the optimization target.

5. The method as claimed in claim 4, wherein the target property ascertained for a respective volume element is how the target function changes in the event of a change in a material density in this volume element.

6. The method as claimed in claim 1, wherein
the check on the support for a respective volume element involves checking whether a cone downwardly directed from this volume element and having a stipulated apex angle meets another material-filled volume element or a supporting element.

7. The method as claimed in claim 1, wherein
method step d) involves checking for the respective volume element whether this volume element supports another volume element in consideration of additive manufacturing, and this is taken as a basis for modifying the target property of the respective volume element such that the target property approaches the optimization target if there is support and/or moves away from the optimization target if there is no support.

8. The method as claimed in claim 7, wherein the check to ascertain whether the respective volume element supports another volume element involves checking whether a cone upwardly directed from the respective volume element and having a stipulated apex angle meets another material-filled volume element.

9. The method as claimed in claim 1, wherein
the object is printed according to the output modified material distribution by means of a 3D printer.

10. An assistance system for computer-aided design of objects for additive manufacturing, configured to perform a method as claimed in claim 1.

11. A 3D printer configured to perform a method as claimed in claim 1 and to print an object according to the output modified material distribution.

12. A computer program product, comprising a computer readable hardware storage device having computer readable program code stored therein, said program code executable by a processor of a computer system to implement a method for computer-aided design of objects for additive manufacturing, configured to perform a method as claimed in claim 1.

13. A computer-readable storage medium having a computer program product, comprising a computer readable hardware storage device having computer readable program code stored therein, said program code executable by a processor of a computer system to implement a method as claimed in claim 12.
